(19) United States
(12) Patent Application Publication
(10) Pub. No.: US 2024/0300043 A1
(43) Pub. Date: Sep. 12, 2024

(54) Split Thread Die Device

(71) Applicant: Adam Mackay, Shoshone, ID (US)

(72) Inventor: Adam Mackay, Shoshone, ID (US)

(21) Appl. No.: 18/505,174

(22) Filed: Nov. 9, 2023

Related U.S. Application Data
(60) Provisional application No. 63/450,128, filed on Mar. 6, 2023.

(51) Int. Cl. B23G 5/04

(52) U.S. Cl. CPC B23G 5/04; B23G 2200/06

(57) ABSTRACT

A split thread die device is disclosed. The device is comprised of a first half and a second half that can be secured to each other around a damaged area of threads of a fastener. The device can then be turned to re-thread the damaged threads. In addition, a top surface of each half is comprised of an opening that extends to the inside surface of each half. The opening allows a cutting lubricant to easily flow from the top surface of each half and onto the threads of the fastener contacting the inside surfaces.

### CROSS-REFERENCE TO RELATED APPLICATION

The present application claims priority to, and the benefit of, U.S. Provisional Application No. 63/450,128, which was filed on Mar. 6, 2023, and is incorporated herein by reference in its entirety.

### FIELD OF THE INVENTION

The present invention relates generally to the field of threading dies. More specifically, the present invention relates to a split thread die device comprised of a first half and a second half that can be secured to each other around a damaged area of threads of a fastener. The device can then be turned to re-thread the damaged threads. Accordingly, the present disclosure makes specific reference thereto. Nonetheless, it is to be appreciated that aspects of the present invention are also equally applicable to other like applications, devices, and methods of manufacture.

### BACKGROUND

Stripped threads can render a threaded fastener unusable. Stripped threads can be re-threaded using a re-threading die. However, existing re-threading dies known in the art are comprised of a singular piece of continuous material. This creates difficulty, as the re-threading die must be worked down the entire thread area of a fastener before reaching the damaged thread area. In addition, existing re-threading dies known in the art must be used with the fastener being re-threaded in the vertical position. This limits the manner and orientation in which threads of a fastener can be re-threaded.

Therefore, there exists a long-felt need in the art for an improved re-threading die. More specifically there exists a long-felt need in the art for a split thread die device. There also exists a long-felt need in the art for a split thread die device that does not have to be applied at the end of a fastener to be used. In addition, there exists a long-felt need in the art for a split thread die device that does not require the fastener be placed in a vertical position to be used. Finally, there exists a long-felt need in the art for a split thread die device that allows a fastener to be more easily lubricated with a cutting lubricant during the re-threading process.

The subject matter disclosed and claimed herein, in one embodiment thereof, comprises a split thread die device. The device is primarily comprised of a first half with at least one female opening, at least one inside surface comprised of at least one male thread cutter, and at least one relief cut, and a second half with at least one male protrusion, at least one inside surface comprised of at least one male thread cutter, and at least one relief cut. The top surface of each half is also comprised of at least one opening that extends to the inside surface of each half such that cutting lubricant can be applied at the top surface and travel through the opening to contact the portion of the fastener contacting the inner surfaces. During use, each half can be attached to each other around the damaged portion of the threads of a fastener. A socket and/or a crescent wrench can then be used with the fastener in a horizontal or vertical position to re-thread the threads of the fastener.

In this manner, the split thread die device of the present invention accomplishes all the foregoing objectives and provides a device that does not have to be applied at the end of a fastener to be used to re-thread a fastener. In addition, the device does not require the fastener be placed in a vertical position to be used. The opening of each half allows a fastener to be more easily lubricated with a cutting lubricant during the re-threading process.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a split thread die device primarily comprised of a first half with at least one female opening, at least one inside surface comprised of at least one male thread cutter, and at least one relief cut and a second half with at least one male protrusion, at least one inside surface comprised of at least one male thread cutter, and at least one relief cut. The device is designed to be used inside a socket of a socket wrench to allow a user to re-thread a threaded fastener such as, but not limited to, a threaded bolt. Because the device has a first half and a second half, the device can easily be placed around the specific area of fastener threads without having to start from the end of the fastener. In addition, the fastener need not be positioned in a vertical orientation.

Each half of the device is half-hexagonal in shape and forms a hexagonal shape when attached together that can be inserted into a socket of a socket wrench. Each half is comprised of at least one relief cut that allows material shaved from the fastener the device is used on during the re-threading process to be cleared such that said shaved material does not collect on the threads of the fastener (and thus prevent the threads from being threading by the device due to obstruction).

The inside surface of each half is preferably curved such that it can engage a fastener. The inside surface is comprised of at least one thread cutter of any pitch known in the art to accommodate the thread pitch of the fastener threads. During use, the thread cutter recuts the threads of the fastener.

The present invention is also comprised of a method of using the device. First, a device is provided comprised of a first half with at least one female opening, at least one inside surface comprised of at least one male thread cutter, and at least one relief cut and a second half with at least one male protrusion, at least one inside surface comprised of at least one male thread cutter, and at least one relief cut. Then, the first half and second half are secured around the threads of a fastener. Then, the fastener can be secured within a vise or other securing device or method in the vertical orientation or horizontal orientation. In one embodiment, each half is comprised of at least one opening that allows cutting lubricant to be poured into the opening at the top surface such that the lubricant flows through the opening at the inside surfaces to cover the threads of the fastener at the inside surface to facilitate cutting. Next, the wrench of the socket is attached so it can be turned such that the device moves towards the head of the fastener and the cutters re-thread and/or clean the threads of the fastener.

Accordingly, the split thread die device of the present invention is particularly advantageous as it provides a device that does not have to be applied at the end of a fastener to be used to re-thread a fastener. In addition, the device does not require the fastener to be placed in a vertical position to be used. Furthermore, the opening of each half allows a fastener to be more easily lubricated with a cutting lubricant during the re-threading process. In this manner, the split thread die device overcomes the limitations of existing re-threading dies known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a split thread die device of the present invention while the first half and the second half are attached in accordance with the disclosed architecture;

FIG. 2 illustrates a perspective view of one potential embodiment of a split thread die device of the present invention while the first half and the second half are separated in accordance with the disclosed architecture;

FIG. 3 illustrates a perspective view of one potential embodiment of a split thread die device of the present invention while the first half and the second half are attached around a fastener within a socket in accordance with the disclosed architecture; and

FIG. 4 illustrates a flowchart of a method of using one potential embodiment of a split thread die device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved re-threading die. More specifically there exists a long-felt need in the art for a split thread die device. There also exists a long-felt need in the art for a split thread die device that does not have to be applied at the end of a fastener to be used. In addition, there exists a long-felt need in the art for a split thread die device that does not require the fastener be placed in a vertical position to be used. Finally, there exists a long-felt need in the art for a split thread die device that allows a fastener to be more easily lubricated with a cutting lubricant during the re-threading process.

The present invention, in one exemplary embodiment, is comprised of a split thread die device. The device is primarily comprised of a first half with at least one female opening, at least one inside surface comprised of at least one male thread cutter, and at least one relief cut and a second half with at least one male protrusion, at least one inside surface comprised of at least one male thread cutter, and at least one relief cut. The device is designed to be used inside a socket of a socket wrench to allow a user to re-thread a threaded fastener such as, but not limited to, a threaded bolt. Because the device has a first half and a second half, the device can easily be placed around the specific area of fastener threads without having to start from the end of the fastener. In addition, the fastener need not be positioned in a vertical orientation.

Each half of the device is half-hexagonal in shape. Said halves form a hexagonal shape when attached together and can then be inserted into a socket of a socket wrench. Each half is comprised of at least one relief cut. The relief cut allows material shaved from the fastener the device is used on during the re-threading process to be cleared. This ensures the shaved material does not collect on the threads of the fastener, and as a result prevent the threads from being threading by the device due to obstruction.

The inside surface of each half is preferably curved such that it can engage a fastener. The inside surface is comprised of at least one thread cutter of any pitch known in the art to accommodate the thread pitch of the fastener threads. During use, the thread cutter recuts the threads of the fastener.

The present invention is also comprised of a method of using the device. First, a device is provided comprised of a first half with at least one female opening, at least one inside surface comprised of at least one male thread cutter, and at least one relief cut and a second half with at least one male protrusion, at least one inside surface comprised of at least one male thread cutter, and at least one relief cut. Then, the first half and second half are secured around the threads of a fastener. Next, the fastener can be secured within a vise or other securing device or method in the vertical orientation or horizontal orientation. In one embodiment, each half is comprised of at least one opening that allows cutting lubricant to be poured into the opening at the top surface such that the lubricant flows through the opening at the inside surfaces to cover the threads of the fastener at the inside surface to facilitate cutting. Next, the wrench of the socket is attached so it can be turned such that the device moves towards the head of the fastener and the cutters re-thread and/or clean the threads of the fastener.

Accordingly, the split thread die device of the present invention is particularly advantageous as it provides a device that does not have to be applied at the end of a fastener to be used to re-thread a fastener. In addition, the device does not require the fastener to be placed in a vertical position to be used. Furthermore, the opening of each half allows a fastener to be more easily lubricated with a cutting lubricant during the re-threading process. In this manner, the split thread die device overcomes the limitations of existing re-threading dies known in the art.

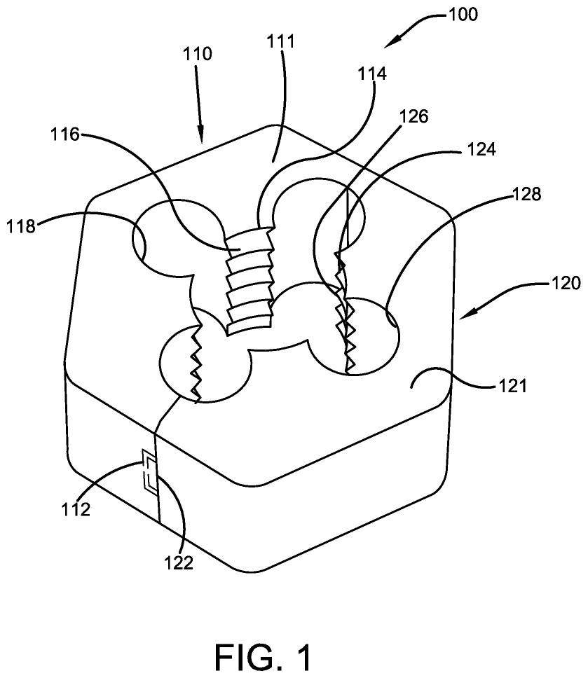

Referring initially to the drawings, FIG. 1 illustrates a perspective view of one potential embodiment of a split thread die device 100 of the present invention while the first half 110 and the second half 120 are attached in accordance with the disclosed architecture. The device 100 is primarily comprised of a first half 110 with at least one female opening 112, at least one inside surface 114 comprised of at least one male thread cutter 116, and at least one relief cut 118 and a second half 110 with at least one male protrusion 122, at least one inside surface 124 comprised of at least one male thread cutter 126, and at least one relief cut 128.

The device 100 is designed to be used inside a socket 12 of a socket wrench 10 to allow a user to re-thread a threaded fastener 14 such as, but not limited to, a threaded bolt. Because the device 100 has a first half 110 and a second half 120, the device 100 can easily be placed around the specific area of fastener threads 16 without having to start from the end of the fastener 14. In addition, the fastener 14 need not be positioned in a vertical orientation. The device 100 is preferably manufactured from a stainless steel or other durable metal that is not easily deformable.

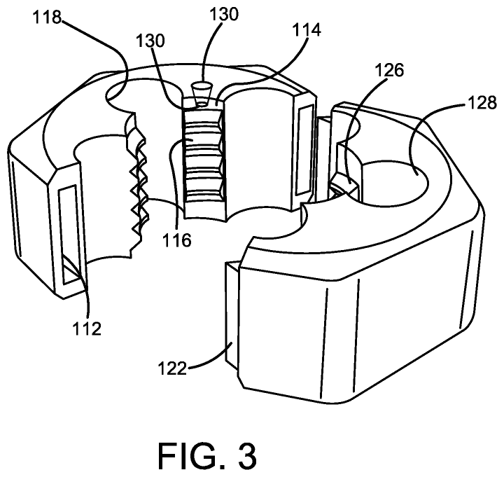

Each half 110,120 is half-hexagonal in shape. When attached together, both halves 110,120 form a hexagonal shape that can be inserted into a socket 12 of a socket wrench 10, as seen in FIG. 3. In different embodiments, each half 110,120 may be sized to form any size of hexagon to fit any size of socket 12.

The first half 110 is comprised of at least one relief cut 118. The relief cut 118 is preferably (but not limited to) circular. The relief cut 118 allows material shaved from the fastener 14 the device 100 is used on during the re-threading process to be cleared such that said shaved material does not collect on the threads 16 of the fastener 14 (and thus prevent the threads 16 from being threading by the device 100 due to obstruction). In addition, the relief cut 118 reduces friction and thus improves the re-threading process.

The inside surface 114 of the first half 110 is preferably curved such that it can engage a fastener 14. The position of the inside surface 114 within the half 110 may differ to accommodate a plurality of fasteners 114 of different diameters. The inside surface 114 is comprised of at least one thread cutter 116. The thread cutter 116 preferably extends away from the inside surface 114 the same height as the threads 16 of the fastener 114. In different embodiments, the thread pitch (and/or threads per inch) of the cutter 116 may be any pitch known in the art to accommodate the thread pitch of the fastener 14 threads 16. During use, the thread cutter 116 recuts the threads 16 of the fastener 14.

The second half 120 is comprised of at least one relief cut 128. The relief cut 128 is preferably (but not limited to) circular. The relief cut 128 allows material shaved from the fastener 14 the device 100 is used on during the re-threading process to be cleared such that said shaved material does not collect on the threads 16 of the fastener 14 (and thus prevent the threads 16 from being threading by the device 100 due to obstruction). In addition, the relief cut 128 reduces friction and thus improves the re-threading process.

The inside surface 124 of the first half 120 is preferably curved such that it can engage a fastener 14. The position of the inside surface 124 within the half 110 may differ to accommodate a plurality of fasteners 124 of different diameters. The inside surface 124 is comprised of at least one thread cutter 126. The thread cutter 126 preferably extends away from the inside surface 124 the same height as the threads 16 of the fastener 124. In different embodiments, the thread pitch (and/or threads per inch) of the cutter 126 may be any pitch known in the art to accommodate the thread pitch of the fastener 14 threads 16. During use, the thread cutter 126 recuts the threads 16 of the fastener 14.

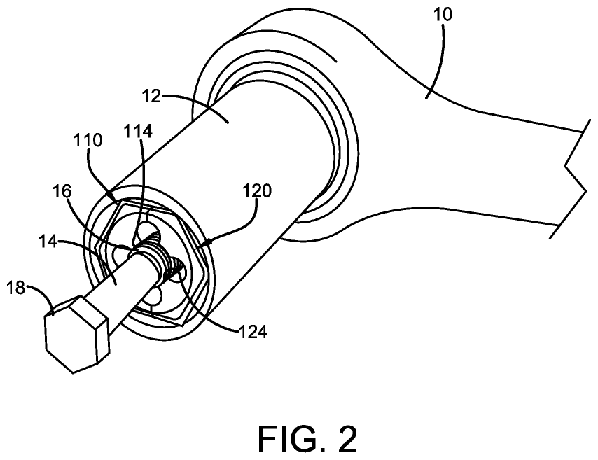

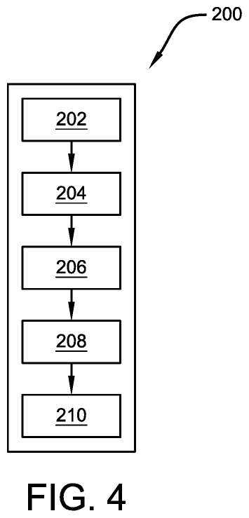

The present invention is also comprised of a method of using 200 the device 100, as seen in FIG. 4. First, a device 100 is provided comprised of a first half 110 with at least one female opening 112, at least one inside surface 114 comprised of at least one male thread cutter 116, and at least one relief cut 118 and a second half 110 with at least one male protrusion 122, at least one inside surface 124 comprised of at least one male thread cutter 126, and at least one relief cut 128 [Step 202]. Then, the first half 110 and second half 120 are secured around the threads 16 of a fastener 14 via inserting at least one male protrusion 122 of the second half 120 into at least one female opening 112 of the first half 110 and inserting both halves 110,120 into a socket 12 [Step ]. Then, the fastener 14 can be secured within a vise or other securing device or method in the vertical orientation or horizontal orientation [Step 206]. In one embodiment, each half 110,120 is comprised of at least one opening 130 (best seen in FIG. 2) that extends from the top surface 111,121 of each half 110,120 to the inside surface 114,124 of each half 110,120. In this embodiment, cutting lubricant can be poured into the opening 130 at the top surface 111,121 such that the lubricant flows through the opening 130 at the inside surfaces 114,124 to cover the threads 16 of the fastener 14 at the inside surface 114,124 to facilitate cutting [Step 208]. Next, the wrench 10 of the socket 12 is attached to can be turned such that the device 100 moves toward the head 18 of the fastener 14 and the cutters 116,126 re-thread and/or clean the threads 16 of the fastener 14 [Step 210]. Alternatively, a wrench 10 such as a crescent wrench can be used if the fastener 14 is secured in the horizontal position.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “split thread die device” and “device” are interchangeable and refer to the split thread die device 100 of the present invention.

Notwithstanding the foregoing, the split thread die device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the split thread die device 100 as shown in the FIGS. are for illustrative purposes only, and that many other sizes and shapes of the split thread die device 100 are well within the scope of the present disclosure. Although the dimensions of the split thread die device 100 are important design parameters for user convenience, the split thread die device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A split thread die device comprising:
a first half comprised of a female opening, a first inside surface comprised of a first male thread cutter, and a first relief cut; and
a second half comprised of a male protrusion, a second inside surface comprised of a second male thread cutter, and a second relief cut.

2. The split thread die device of claim 1, wherein the first relief cut is comprised of a circular relief cut.

3. The split thread die device of claim 1, wherein the second relief cut is comprised of a circular relief cut.

4. The split thread die device of claim 1, wherein the first half is comprised of a half-hexagonal shape.

5. The split thread die device of claim 1, wherein the second half is comprised of a half-hexagonal shape.

6. The split thread die device of claim 1, wherein the male thread cutter is comprised of a thread pitch.

7. The split thread die device of claim 1, wherein the male thread cutter is comprised of a metal material.

8. A split thread die device comprising:
a first half comprised of a female opening, a first inside surface comprised of a first male thread cutter, a first relief cut, and a first opening; and
a second half comprised of a male protrusion, a second inside surface comprised of a second male thread cutter, a second relief cut, and a second opening.

9. The split thread die device of claim 8, wherein the first relief cut is comprised of a circular relief cut.

10. The split thread die device of claim 8, wherein the second relief cut is comprised of a circular relief cut.

11. The split thread die device of claim 8, wherein the first half is comprised of a half-hexagonal shape.

12. The split thread die device of claim 8, wherein the second half is comprised of a half-hexagonal shape.

13. The split thread die device of claim 8, wherein the first opening extends from a first top surface of the first half to the first inside surface.

14. The split thread die device of claim 8, wherein the second opening extends from a second top surface of the second half to the second inside surface.

15. The split thread die device of claim 8, wherein the male thread cutter is comprised of a thread pitch.

16. The split thread die device of claim 8, wherein the male thread cutter is comprised of a metal material.

17. A method of using a split thread die device, the method comprising:
providing a split thread die device, the split thread die device comprised of a first half a female opening, a first inside surface comprised of a first male thread cutter, and a first relief cut, and a second half comprised of a male protrusion, a second inside surface comprised of a second male thread cutter, and a second one relief cut;
securing the first half to and second half around a thread of a fastener by inserting the male protrusion into the female;
inserting the first half and the second half into a socket or a crescent wrench while the first half and the second half are secured around the fastener;
securing the fastener in a vertical position or a horizontal position;
applying a cutting lubricant into a first opening of the first half and a second opening of the second half; and
turning the socket or the wrench such that the split thread die device moves down the fastener towards a head to re-thread and/or clean the threads of the fastener.

18. The method of claim 17, wherein the first half is comprised of a half-hexagonal shape.

19. The method of claim 17, wherein the second half is comprised of a half-hexagonal shape.

20. The method of claim 17, wherein the first male thread cutter, the second male thread cutter, and the thread of the fastener are all comprised of a uniform thread pitch.
